(19) United States
(12) Patent Application Publication
(10) Pub. No.: US 2002/0143499 A1
(43) Pub. Date: Oct. 3, 2002

(54) Methods and apparatus for communicating information via a network

(75) Inventors: Tomoaki Kurosawa, Tokyo (JP); Toshimichi Muramatsu, Tokyo (JP)

Correspondence Address: LYON & LYON LLP, 633 WEST FIFTH STREET, SUITE 4700, LOS ANGELES, CA, 90071, US

(73) Assignee: GRAPHIN CO., LTD

(21) Appl. No.: 10/044,827

(22) Filed: Jan. 11, 2002

(30) Foreign Application Priority Data
Jan. 12, 2001 (JP) 2001-039208

(51) Int. Cl. G06F 15/00

(52) U.S. Cl. 702/188

(57) ABSTRACT

In response to receiving a transmit request REQ1 from a first client apparatus (1), the server (11) transmits a group address INF1 to the first client apparatus (1). The server (11) first transmits the first block X1, which is selected from blocks X1 to X4 that were subdivided from the requested information with the group address, via the network (10). When the server (11) receives a transmit request REQ2 from a second client apparatus (2) after transmitting block X1 to the first client apparatus (1), the server (11) transmits a group address INF2 to the second client apparatus (2). Further, the server (11) transmits the second, third and fourth blocks (X2 to X4) with the group addresses INF1 and INF2 via the network (10). The transmission process is completed after the server (11) has transmitted the first block X1 with the group address INF2 via the network (10).

### BACKGROUND OF THE INVENTION

1. Technical Field

The present invention relates to information communication apparatus and methods for transmitting and receiving information such as data. More particularly, the present invention relates to client-server communication systems that transmit information from a server to a plurality of client apparatus via a network.

2. Description of the Related Art

Known client-server communication systems connect a server with a plurality of client apparatus via a communication line (network), such as a LAN or the Internet. In this type of client-server communication system, designated information is sent from a server to a plurality of client apparatus.

Generally, if a large amount of information/data will be sent, such as image data or an image file, the quantity of transmitted data will be extremely large compared to a text file or other types of files. Moreover, the processing capacity of the server (for example, the quantity of data that can be sent at one time) and the processing capacity of the communication line (for example, the quantity of data that can be transferred at one time) are limited. Furthermore, even if the processing capacities of the server and the communication line are sufficient, no other data can be sent while a large quantity of data is being sent via the communication line until the transmission of that data is complete. Therefore, known client-server communication systems typically subdivide the information to be transmitted into a plurality of blocks and then transmit the plurality of blocks. For example, the server may subdivide the information to be transmitted into blocks of a specified data size. Then, the server transmits each subdivided block to the client apparatus via the communication line.

For example, the broadcast method and the unicast method are known methods for transmitting information in a network system.

The broadcast method is typically used to transmit information (such as data or a file) to a large number of unspecified apparatus connected to a network. In order to transmit information using the broadcast method, a specific address is used as the destination address for the information transmission to indicate the entire network. In the broadcast method, all apparatus connected via the network receive all information transmitted via the network. If the received information is relevant to the apparatus, the apparatus accepts the information; if irrelevant to the apparatus, the apparatus discards the information. Because the broadcast method places a heavy load on the network, it can only be used for certain applications. For example, in order to automatically acquire setting information from the server that is connected via the network, the broadcast method is used to locate the server that contains the setting information. “Setting information” is parameter used for connecting “Real” Server. As just one example, cable television (“CATV”) is used. A cable television system provides many channels. However, many cable network systems provide a programming guide. After seeing this program channel, the user knows what programs are broadcasting at that time. “Setting information” is analogous to this “program channel”. To receive this “setting information”, the cable set top box (i.e., the client) knows information regarding the server, e.g., the type and locations. In this cable television example, there are at least two servers. One server is a broadcasting-only server, which only provides information about other servers. The other servers store data (typically images and sound file, or other useful data) and use the unicast method.

On the other hand, the unicast method is typically used for transmitting information to a specific apparatus that is connected via the network. When transmitting information using the unicast method, the address of the specific apparatus is used as the destination address. In the unicast method, an apparatus connected via the network only receives the information, if the specific address for that specific apparatus is identified.

In addition, the multicast method is typically used to simultaneously transmit information to a specific group of client apparatus connected via the network. This specific group is also called a sub-network, because it denotes only a portion of the network. When transmitting information using the multicast method, an address that indicates a specific group (sub-network) is used as the destination address.

Further, the near-on-demand method is a known method that utilizes the multicast method.

In a client-server type network system, the unicast method, the multicast method and the near-on-demand method are used to transmit information (more specifically, information subdivided into blocks) from the server to client apparatus. The operation will be described below of examples of transmitting information from a server to a plurality of client apparatus using the unicast method, the multicast method or the near-on-demand method. These descriptions concern a typical network, i.e., a TCP/IP (Transmission Control Protocol/Internet Protocol) network, and the transmitted information may have any arbitrary structure and format.

Unicast Method

The unicast method individually transmits information (data) from a server to each client apparatus. For example, if a plurality of client apparatus send a request to transmit the same information to the server, the server will individually transmit the requested information to each client apparatus that requested transmission of the designated information.

Thus, when information is transmitted from a server to a client apparatus using the unicast method, a 1:1 TCP connection (logic channel) is secured between the server and the client apparatus in order to reliably transmit the information. The server subdivides the information to be transmitted into a plurality of blocks of a specified size. Then, the server transmits the blocks sequentially from the first block via the secured TCP connection to each client apparatus. For example, if the information to be transmitted is subdivided into 4 blocks (i.e., X1, X2, X3 and X4), the server transmits each block in the order of X1, X2, X3 and X4 to each client apparatus.

The unicast method further utilizes a retransmission process in order to ensure the reliability of transmission of the information. For example, if the client apparatus detects an error in a received block, the client apparatus requests the server to retransmit the block in which the error occurred. When the server receives a retransmission request from the client apparatus, the server retransmits the requested block to the client apparatus.

Further, in the unicast method, the server transmits information via a secured connection to each client. Consequently, the server transmits different blocks within a certain time interval. For example, if information comprising blocks X1 to X4 will be transmitted, the server sequentially transmits each block in the order X1, X2, X3, X4 to the client apparatus that requested transmission of the information. Thus, within a certain time interval, the server transmits block X4 to client apparatus (1), block X3 to client apparatus (2), block X1 to client apparatus (3), and block X2 to client apparatus (4). In other words, the server transmits different blocks within a certain time interval.

The operation for transmitting information from the server to the client apparatus using the unicast method will be described in further detail with reference to the sequence diagram shown in FIG. 4. Client apparatus (1) sends a transmit request (dispatch request) for designated information REQ1 to the server. The server establishes a communication path (connection) with client apparatus (1) and then transmits the requested information in subdivided blocks (i.e., in the order of X1 to X4) to client apparatus (1). Blocks X1-1 to X4-1 indicate blocks X1 to X4 that are transmitted to client apparatus (1).

If the server receives transmit request REQ2 from client apparatus (2) while transmitting the information to client apparatus (1), the server will also begin to transmit information to client apparatus (2). For example, if the server receives a transmit request REQ2 from client apparatus (2) while transmitting block X3 (X3-1) to client apparatus (1), then at the next time interval, the server will transmit block X4 (X4-1) to client apparatus (1) and block X1 (X1-2) to client apparatus (2).

In this manner, the unicast method requires the server to individually transmit each block to each client. Consequently, as the number of transmit requests (dispatch requests) increases (in particular, the number of transmit requests until the time when the transmission of all blocks for one client apparatus is completed), the number of blocks that the server must transmit within a specific time interval also increases. For example, the condition will occur in which the server must transmit block X1 to client apparatus (1), block X2 to client apparatus (2), block X3 to client apparatus (3), and block X4 to the client apparatus (4).

As a further example, if the server is capable of transmitting a maximum of N blocks to a client apparatus per unit time and the server receives transmit requests from M number of client apparatus, the server will transmit (x) blocks via the network per unit time. In this case, if (x) is not satisfied, wherein B is the number of blocks that the network can transfer per unit time (also known as the “network bandwidth”), then it is not possible to transmit all the blocks to all client apparatus within the unit time. In other words, if the network bandwidth B is less than the number of blocks that the server is required to transmit per unit time (x), the server can not transmit blocks that exceed the network bandwidth B. In such cases, for example, the server either requires a new client apparatus to wait for the transmission of blocks to that client apparatus, or reduces the number of blocks that are transmitted to each client apparatus per unit time.

In the alternative, the server may read blocks from a storage device and then transmit the blocks to each client apparatus. In this case, there is a limit to the number of times that a server can read blocks from the storage device per unit time. In other words, the readable number limits the number of blocks that the server can transmit via the network. Therefore, even if the network has a relatively large network bandwidth, the number of client apparatus to which the same block can be transmitted within a certain time interval is limited by the processing capacity of the server.

Thus, in the unicast method, the network bandwidth of the network and/or the processing capacity of the server may limit the number of client apparatus to which information can be simultaneously transmitted.

Multicast Method

In the multicast method, information can be simultaneously transmitted to many client apparatus (a specific group of client apparatus). Moreover, the IP multicast method is one type of multicast method, in which the same information is simultaneously transmitted to a specific group (broadcast group) of apparatus within a TCP/IP network. In this method, a special address identifies the specified group and this address is known as a class D IP address.

In a TCP/IP network, the broadcast method can be used to simultaneously transmit information from the transmitting apparatus (e.g., the server) to all receiving apparatus (e.g., client apparatus) using a UDP (User Datagram Packet). The IP multicast method is thus a special type of broadcast method. Further, the broadcast method transmits information (data) to the entire network. Any client apparatus that does not require the transmitted information will discard the transmitted information.

On the other hand, the IP multicast method transmits information (data) only to client apparatus that belong to the specified group. In other words, the IP multicast method uses a server that specifies a group address and sequentially transmits blocks. Even though the blocks are transmitted over the network, the client apparatus will only receive the blocks having the address that is identical to the client's own group address. In the IP multicast method, it is not necessary to secure a connection, which is required in the unicast method. Therefore, the IP multicast method is a non-connection type communication method.

The operation for transmitting information from the server to the client apparatus using the IP multicast method will be described in further detail with reference to the sequence diagram shown in FIG. 5. Prior to the transmit start time t1, client apparatus (1) sends a transmit request (dispatch request) REQ1 via the network, which requests the transmission of the information (data) provided in blocks X1 to X4. In response to receiving the transmit request REQ1 from client apparatus (1), the server transmits a group address INF1 via the network to client apparatus (1). In response to receiving group address INF1 sent from the server, client apparatus (1) stores the group address INF1 as the group address of the group to which it belongs.

At the transmit start time t1, the server sequentially transmits blocks X1 through X4 via the network. That is, blocks X1 through X4 are transmitted via the network in the sequence specified by the group address INF1. Client apparatus (1) receives the blocks having the address that is identical with its own group address INF1.

Prior to the next transmit start time t2, the server transmits the group address INF2 via the network to client apparatus (2) in response to receiving the transmit request REQ2 from client apparatus (2). In response to receiving the group address INF2 sent from the server, client apparatus (2) stores the group address INF2 as the group address of the group to which it belongs. Also, in response to receiving the request REQ3 sent from client apparatus (3), the server transmits the group address INF3 via the network to client apparatus (3). In response to receiving the group address INF3 sent from the server, client apparatus (3) stores the group address INF3 as the group address of the group to which it belongs.

At the transmit start time t2, the server sequentially transmits blocks X1 through X4 via the network. In other words, the group addresses INF2 and INF3 are specified for blocks X1 through X4 and then these blocks are sequentially transmitted via the network. Client apparatus (2) and client apparatus (3) receive those blocks having the specified group address that is identical their respective group address INF2 or INF3. Therefore, in the IP multicast method, the server sequentially reads each block from the storage device, which specifies the group address, and then transmits the block of data via the network.

If the server is capable of transmitting a maximum of N blocks per unit time using the IP multicast method, the number of blocks transmitted via the network per unit time is N, regardless of the number of clients M. Consequently, the IP multicast method differs from the unicast method, because the number of blocks that can be received by each client per unit time does not change, even if the number of clients increases. Further, according to the unicast method, the server verifies that the client apparatus has received a block, and then transmits the next block. However, in the IP multicast method, the server does not include a function for detecting whether there is a missing block on the network. Therefore, the client apparatus must be equipped with error processing functions, e.g., to detect the missing block and to retransmit the request for the missing block.

Moreover, as the amount of the error processing by the client apparatus increases, the number of blocks that must be transmitted from the server via the network also increases. In this case, the IP multicast method can not efficiently utilize the network bandwidth. Furthermore, in the IP multicast method, the server begins to transmit information (blocks) at a specified transmit start time. Therefore, after sending a transmit request, the client apparatus must wait until the next transmit start time.

Near-On-Demand

The near-on-demand method provides n channels that can transmit information using the IP multicast method. Each channel begins to transmit information at a different start time. The server assigns the channel, which is available to receive the information the earliest, to the client apparatus. Therefore, the near-on-demand method reduces the time interval from the time when a client apparatus sends a transmit request until the time when the client apparatus receives the information.

The operation for transmitting information from the server to the client apparatus using the near-on-demand method will be described in further detail with reference to the sequence diagram shown in FIG. 6. FIG. 6 shows 2 channels (ch1 and ch2) that are capable of transmitting information using the IP multicast method.

Prior to the transmit start time t1 for ch1, client apparatus (1) sends the transmit request (dispatch request) REQ1 via the network, thereby requesting the transmission of the information (data) included in blocks X1 through X4. In response to receiving the transmit request REQ1 from client apparatus (1), the server transmits the group address INF1 of ch1 via the network to client apparatus (1). Client apparatus (1) receives the group address INF1 of ch1 sent from the server and stores it as the group address of the group of ch1 to which it belongs.

At the transmit start time t1 for ch1, the server specifies blocks X1 through X4 with group address INF1 and then transmits the blocks in sequence over ch1. In this case, X1 (ch1) indicates block X1 that is transmitted over ch1. Client apparatus (1) receives the blocks transmitted over ch1 that have an address identical to its own group address INF1.

Prior to the transmit start time t2 for ch2, in response to receiving the transmit request REQ2 from client apparatus (2), the server transmits the group address INF2 of ch2 via the network to client apparatus (2). Client apparatus (2) receives the group address INF2 of ch2 sent from the server and stores INF2 as the group address of the group of ch2 to which it belongs.

At the transmit start time t2 for ch2, the server specifies blocks X1 through X4 with the group address INF2 and then transmits the blocks in sequence over ch2. Client apparatus (2) receives the blocks transmitted over ch2 that have an address identical to its own group address INF2.

Prior to the next transmit start time t3 for ch1, in response to receiving the transmit request REQ3 from client apparatus (3), the server transmits the group address INF3 of ch3 to client apparatus (3). Similarly thereafter, client apparatus (3) receives the blocks transmitted over ch1 that have an address identical to its own group address INF3.

If the server is capable of transmitting a maximum of N blocks over each channel on the network per unit time using the near-on-demand method, the maximum number of blocks that can be transmitted via the network per unit time is (x). Therefore, in the near-on-demand method, the transfer speed and the wait time until receiving the information depend on the number of channels. For example, if the number of channels n is increased, the wait time until receiving the information will decrease. However, the number of blocks that can be received per unit time also will decrease. Moreover, similar to the IP multicast method, the client apparatus must be equipped with error processing functions, e.g., missing block detection and retransmission of the requested missing block.

The unicast method, IP multicast method and near-on-demand methods have the following advantages and disadvantages.

Because the IP multicast method and near-on-demand method transmit one block to a plurality of client apparatus, the transmission load on the server is relatively low. However, a large-capacity network must be provided, especially for the near-on-demand method. Moreover, it is necessary to consider error processing.

On the other hand, the unicast method provides highly reliable information transmission. However, as the number of client apparatus increases, a high capacity server and a network having a large network bandwidth become necessary.

In the unicast method, after receiving a transmit request from a client apparatus, the server begins to transmit the information to the client apparatus within as short a time interval as the server can accommodate. However, in the IP multicast method, the server predetermines the time at which each block is transmitted. In other words, after sending a transmit request, the client apparatus must wait until the transmit start time for the transmission of the first block to begin. The near-on-demand method using the IP multicast method thus provides a means for reducing the wait time. However, if many retransmit requests are transmitted during a certain time interval, the number of blocks transmitted per unit time via the network will increase.

The utilization of network bandwidth will be further described with numeric examples. For example, if information (data) having 3,600 blocks is transmitted to 10 clients for 1 hour and the blocks are transmitted via the network at a rate of 1 block per second, the total number of transmitted blocks per hour is as follows.

Using the unicast method: 3600×10=36,000 blocks.

Using the IP multicast method: 3,600 blocks.

Using the near-on-demand method with a 15 minute wait time (=4 channels): 14,400 blocks.

Using the near-on-demand method with a 30 minute wait time (=2 channels): 7,200 blocks

Using the near-on-demand method with a 1 minute wait time (=60 channels): 216,000 blocks

The near-on-demand method is the least effective for bandwidth utilization. Therefore, assuming the present state of communication network infrastructures, the near-on-demand method is impractical for use in information transmission, and implementation is difficult since it requires large startup costs. Further, the unicast method utilizes the network bandwidth more efficiently than the near-on-demand method. However, the number of client apparatus for which transmit requests can be handled is limited by both bandwidth utilization factors and by the capacity of the server to read from the storage device. The IP multicast method is the most advantageous from the viewpoint of bandwidth utilization. However, after sending a transmit request, the client must wait until the next transmit start time of the first block.

In addition, problems incurred in error processing for these three methods also must be considered. Because correction and retransmission are automatically preformed when errors occur in the unicast method, the reliability of information transmission is high. However, the IP multicast method and near-on-demand methods require error processing to be performed in addition to the normal block transmission processing.

### SUMMARY OF THE INVENTION

It is, accordingly, one object of the present teachings to provide information communication apparatus and methods that allow an information receiving apparatus (e.g., client apparatus) to receive designated information from an information transmitting apparatus (e.g., a server) within a shorter time.

In one aspect of the present teachings, a modified multicast method is utilized and the information transmitting apparatus may transmit the designated information to a plurality of information receiving apparatus only one time. As a result, the load on the information transmitting apparatus and on the network (communication line) is reduced. If a request to transmit the designated information is received from a second information receiving apparatus while transmitting blocks comprising the designated information from the information transmitting apparatus to a first information receiving apparatus, the transmission of the information to the second information receiving apparatus begins with a middle block. Consequently, because the second information receiving apparatus does not have to wait for the next transmit start time of the first block of the designated information, the second information receiving apparatus can receive the designated information within a shorter time.

In another aspect of the present teachings, if the information transmitting apparatus receives a request to transmit the designated information from a second information receiving apparatus while the information transmitting apparatus is transmitting the blocks comprising the designated information to the first information receiving apparatus using the multicast method, the information transmitting apparatus immediately transmits the blocks comprising the designated information to the first and second information receiving apparatus using the multicast method. At this time, the group address for the first information receiving apparatus and the group address for the second information receiving apparatus are specified for blocks that have not yet been transmitted to the first information receiving apparatus. Further, the group address for the second information receiving apparatus is specified for blocks that have already been transmitted to the first information receiving apparatus. Thus, because the block transmission to the second information receiving apparatus begins quickly, the wait time for the second information receiving apparatus is reduced.

In this case, subdivision sequence information is preferably appended to the blocks transmitted from the information transmitting apparatus. The information receiving apparatus can reconstitute the information by assembling the blocks based on the subdivision sequence information. Therefore, the process for decoding the designated information is simplified. Moreover, by using the subdivision sequence information, missing blocks can be easily identified.

In another aspect of the present teachings, the blocks are preferably cyclically transmitted in the predetermined sequence, as long as requests to transmit the designated information are being received from other information receiving apparatus prior to transmitting all blocks comprising the designated information to at least one information receiving apparatus. This simplifies the transmission of blocks by the information transmitting apparatus. In addition, the blocks are preferably stored in a storage device, and then the blocks are read in the predetermined sequence from the storage device.

In another aspect of the present teachings, the information transmitting apparatus may be configured to transmit blocks comprising information supplied from information supply device, such as an imaging apparatus, and a subdivision sequence information of each block. Therefore, the information receiving apparatus can receive information other than the information stored in the storage device.

In another aspect of the present teachings, the information transmitting apparatus may be configured to append error detection/correction information to each block. Thus, the information receiving apparatus can correct data errors in a received block and reconstitute the correct information.

In another aspect of the present teachings, the information transmitting apparatus may include a retransmission function in order to be able to reconstitute correct information, even if it is not possible to correct the data of the block or a block is missing. In such a case, the block transmission efficiency of the information transmitting apparatus is improved due to the use of a storage device for transmitting blocks of data, which stores blocks for transmitting, and the storage device for retransmission of the same blocks of data, which stores blocks for retransmission.

Moreover, when the retransmission is performed, a suitable re-transmission method is preferably selected based on the status of bandwidth utilization of the communication line (network). For example, the information transmitting apparatus may be configured to send blocks for retransmission using either the multicast method or the unicast method depending on the status of bandwidth utilization of the communication line. The status of bandwidth utilization of the communication line can be determined, for example, based upon the result of comparing a limit value with the number of blocks transmitted via the communication line or received from the communication line per unit time.

In another aspect of the present teachings, the information transmitting apparatus may be configured to regulate the number of blocks transmitted via the communication line. Thus, the quantity of data transmitted on the communication line within a predetermined time interval will not exceed a predetermined quantity. As a result, the load on the communication line can be suitably regulated and degradation of the transfer efficiency can be avoided.

In another aspect of the present teachings, the information transmitting apparatus may specify a group address of an information receiving apparatus when the information transmitting apparatus receives a transmit request from the information receiving apparatus. Thus, a plurality of information receiving apparatus can be divided into appropriate groups.

In another aspect of the present teachings, the information transmitting apparatus may set the communication line to the information receiving apparatus when the information transmitting apparatus receives a transmit request from the information receiving apparatus. Thus, each block can be efficiently transmitted to the information reception apparatus and the load on the communication line can be reduced.

Additional objects, features and advantages of the present invention will be readily understood after reading the following detailed description together with the accompanying drawings and the claims.

### BRIEF DESCRIPTION OF THE DRAWINGS

FIG. 1 is a sequence diagram of one representative method for transmitting designated information according to the present teachings.

FIG. 2 is a block diagram of a representative embodiment that can implement the representative method shown in FIG. 1.

FIG. 3 is a block diagram of another representative embodiment that can implement the representative method for transmitting designated information shown in FIG. 1.

FIG. 4 is a sequence diagram showing transmission of designated information using the known unicast method.

FIG. 5 is a sequence diagram showing transmission of designated information using the known multicast method.

FIG. 6 is a sequence diagram showing transmission of designated information using the known near-on demand method.

FIG. 7 is a block diagram of another representative embodiment that can implement the representative method shown in FIG. 1.

FIG. 8 is a sequence diagram showing another representative method according to the present teachings.

FIG. 9 is a flowchart showing a portion of the operation of the server shown in FIG. 2.

FIG. 10 is a flowchart showing another portion of the operation of the server shown in FIG. 2.

FIG. 11 is a flowchart showing a retransmission operation of the server shown in FIG. 2.

FIG. 12 is a block diagram of a representative client (information receiving apparatus) according to the present teachings.

FIG. 13 is a diagram showing a portion of the operation of a representative information receiving apparatus according to the present teachings.

FIG. 14 is a diagram showing an example of the configuration of a block of data according to the present teachings.

### DETAILED DESCRIPTION OF THE INVENTION

The unicast method and multicast methods are known methods for transmitting designated information from an information transmitting apparatus (e.g., a server) to a plurality of information receiving apparatus (e.g., client apparatus or devices).

If the known unicast method is used, the amount of information transmitted via the communication line increases in proportion to the number of information receiving apparatus. Therefore, as the number of information receiving apparatus increases, the wait time of the information receiving apparatus after sending a request to transmit the designated information until receiving the designated information becomes longer.

If the known multicast method is used, the information transmitting apparatus may send the designated information one time to a plurality of information receiving apparatus. Therefore, compared to the unicast method, less information is transmitted via the communication line (network) and the wait time is shorter. However, when using the known multicast method, the information receiving apparatus must wait until the next transmit start time of the information, because the transmit start time for the information is fixed.

Therefore, one object of the present teachings is to reduce the wait time between sending a request to transmit designated information and receiving the designated information. Thus, in one representative example, the known multicast method is modified to reduce the amount of designated information that is transmitted from the information transmitting apparatus via the communication line. Therefore, because the load of the information transmitting apparatus and on the communication line can be reduced, the wait time for the information receiving apparatus can be reduced. Further, if a request to transmit the designated information is received from a second information receiving apparatus while transmitting blocks subdivided from the designated information to a first information receiving apparatus, the information transmitting apparatus will begin to transmit blocks from a middle block to the second information receiving apparatus.

At this time, for blocks that have not yet been transmitted to the first information receiving apparatus, the information transmitting apparatus specifies a group address of the group affiliated with the first information receiving apparatus and a group address of the group affiliated with the second information receiving apparatus. Then, remaining blocks are transmitted with the group address of the first information receiving apparatus and the group address of the second information receiving apparatus. Moreover, for blocks that have already been transmitted to the first information receiving apparatus, the information transmitting apparatus only transmits those blocks with the group address of the second information receiving apparatus. Therefore, because the second information receiving apparatus can start to receive the blocks from a middle block, even while the information transmitting apparatus is transmitting blocks to the first information receiving apparatus, the wait time of the second information receiving apparatus is reduced.

For example, because the total number of blocks that comprise the designated information is known in advance, even if reception begins with a middle block, the information receiving apparatus can correctly reconstitute the designated information. In a representative embodiment of the present teachings, a block is transmitted together with its subdivision sequence information. In this case, the reconstituting process is simplified because the designated information can be reconstituted by simply assembling the blocks in the sequence specified by the subdivision sequence information appended to each block. Moreover, based on the subdivision sequence information, the information receiving apparatus can readily identify whether there are any missing blocks.

If the information transmitting apparatus begins to transmit to the second information receiving apparatus from a middle block, the information transmitting apparatus must transmit any remaining blocks to the second information receiving apparatus after transmitting all blocks to the first information receiving apparatus. In another representative embodiment of the present teachings, the information transmitting apparatus transmits blocks cyclically in a predetermined sequence, thereby simplifying the process for transmitting blocks by the information transmitting apparatus. In this case, the transmission process can be simplified by storing blocks in advance in a storage device and configuring the information transmitting apparatus to read the stored blocks in the predetermined sequence.

In another representative embodiment of the present teachings, the information transmitting apparatus can transmit blocks that have been subdivided from information supplied from information supply device, such as an imaging device. As a result, more types of information can be supplied to the information transmitting apparatus.

When transmitting blocks via the communication line, data within a block may drop out or change (e.g., be corrupted) during transmission via the communication line. In this case, the information receiving apparatus can not ordinarily reconstitute the correct information. In another representative embodiment of the present teachings, the information transmitting apparatus appends error detection/correction information to the blocks. Thus, the information receiving apparatus can detect and correct data errors based on the error detection/correction information included in the received block. If subdivision sequence information is also appended to the block, the information receiving apparatus can identify that a block has been incorrectly received (e.g., a subdivision sequence information is missing).

If data is missing from a received block or if a block is entirely missing, the information receiving apparatus must receive that block again from the information transmitting apparatus. In another representative embodiment of the present teachings, a retransmit function is provided for these types of situations. For example, the information receiving apparatus may send a request to retransmit the blocks with the missing data or missing blocks to the information transmitting apparatus. The information transmitting apparatus sends the requested block in order to retransmit or send all information blocks (e.g., including the missing block) to the information receiving apparatus that sent the retransmit request.

In another representative embodiment of the present teachings, a first storage device may be provided to store blocks for transmission and a second storage device may store blocks for re-transmission. The first and second storage devices may be combined (or integrated) or may be separate. Thus, in this embodiment, when transmitting a block of information, the information transmitting apparatus can send a block stored in the first storage device for transmitting. Further, when re-transmitting a block, the information transmitting apparatus can send a block stored in the second storage device for re-transmission. Thus, the transmitting process using the information transmitting apparatus can be simplified.

When re-transmitting a block, a suitable retransmission method is preferably selected based upon the usage status (e.g., the quantity of data) of the communication line. In another representative embodiment of the present teachings, the information transmitting apparatus may transmit data using the multicast method when a relatively large quantity of data is being transmitted via the communication line. Further, the unicast method may be used when a relatively small quantity of data is being transmitted via the communication line. The usage status of the communication line may be determined, e.g., based on the result of comparing the number of blocks currently being transmitted via the communication line (network) to a limit value.

If a relatively large quantity of data (load) is on the communication line, the data transfer efficiency may deteriorate. Thus, in another representative embodiment of the present teachings, the information transmitting apparatus may regulate the number of blocks transmitted via the communication line. In this case, the quantity of data on the communication line within a predetermined time interval does not exceed a predetermined quantity. As a result, the load on the communication line can be suitably regulated.

The group address of the information receiving apparatus may be set in advance, or may be set each time when information is transmitted. In another representative embodiment of the present teachings, when a transmit request is received from information receiving apparatus, the information transmitting apparatus sets the group address for the information receiving apparatus, and transmits the information with the group address to the information receiving apparatus. Thus, the information receiving apparatus that sent the request to transmit the designated information can be divided into appropriate groups.

When transmitting blocks from the information transmitting apparatus, blocks may be transmitted to all communication lines. However, the communication line is preferably arranged such that the blocks are transmitted to a specific area. In another representative embodiment of the present teachings, when a transmit request is received from the information receiving apparatus, the information transmitting apparatus identifies the area of the information receiving apparatus, and then sets the communication line so that blocks can reach the area. In this case, because blocks are not transmitted to unnecessary communication lines, the load on the communication line (network) decreases and blocks can be efficiently transmitted to the information receiving apparatus.

Each of the additional features and method steps disclosed above and below may be utilized separately or in conjunction with other features and method steps to provide improved information communication apparatus and methods. Representative examples of the present invention, which examples utilize many of these additional features and method steps in conjunction, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detail description may not be necessary to practice the invention in the broadest sense, and are instead taught merely to particularly describe representative examples of the invention. Moreover, various features of the representative examples and dependent claims may be combined in ways that are not specifically enumerated in order to provide additional useful embodiments of the present teachings.

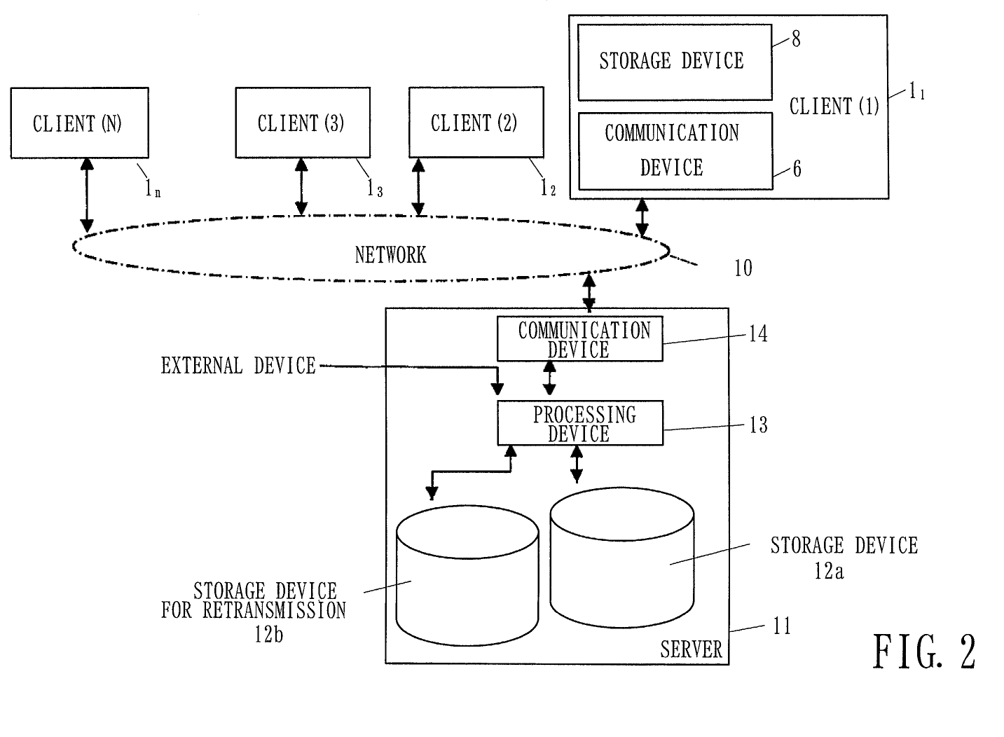

FIG. 2 shows a block diagram of a representative embodiment of one type of information communication apparatus according to the present teachings. A client-server type communication system is exemplified for transmitting designated information from a server to at least one client apparatus via a network. The client-server type communication system may include a plurality of client apparatus (1 to n), a server 11 and a network 10. In this embodiment, the network 10 preferably uses the TCP/IP protocol, such as is used for the Internet, a local area network (“LAN”), a wide area network (“WAN”) or cable television (“CATV”).

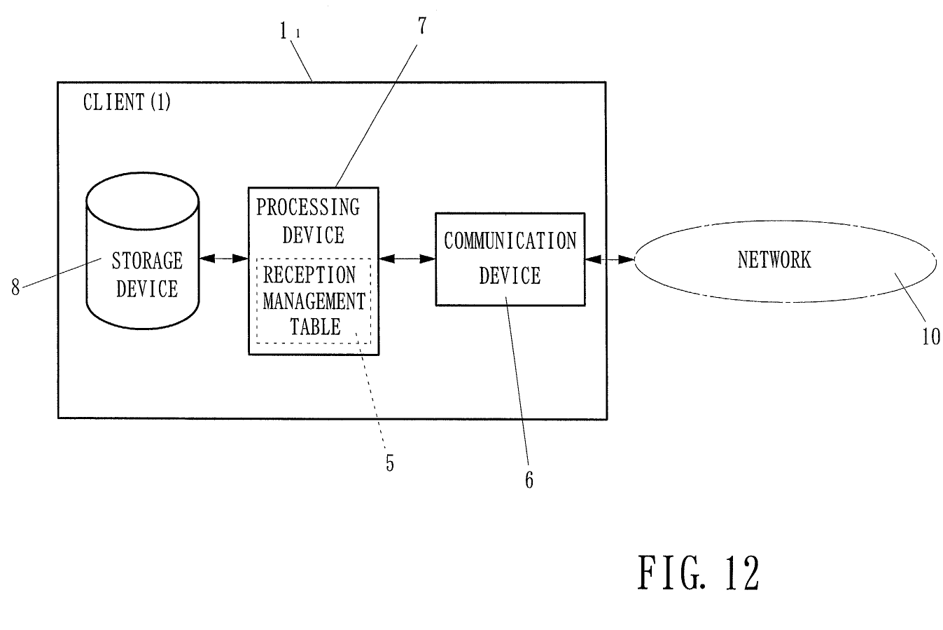

As shown in FIG. 12, each client apparatus (1 to n) may include, e.g., a communication device 6, a storage device 8, a processing device (CPU) 7 and a display (not shown). The processing device 7 communicates with the server via the network 10 using the communication device 6. The processing device 7 also performs various types of processing. For example, the processing device 7 may send a transmit request, receive and store the blocks in the storage device 8, detect errors (such as missing data in a received block or a missing block) and send a retransmit request, and receive retransmitted blocks and store the blocks in the storage device 8.

Representative client apparatus (1 to n) include personal computers and set top boxes (STB). A receiving management table 5 may be utilized to manage the received blocks. Although the receiving management table 5 is located in the processing device 7 shown in FIG. 12, it may also be located in the storage device 8 or elsewhere in the client apparatus (1 to n).

Referring back to FIG. 2, the server 11 preferably includes a first storage device (storage device for transmitting) 12a, a second storage device (storage device for re-transmissions) 12b, a processing device (CPU) 13 and a communication device 14. The processing device 13 preferably communicates with each client apparatus (1 to n) via the network 10 using the communication device 14. The processing device 13 also performs various types of processing. For example, the processing device 13 may direct storage of information supplied from an external device (for example, an imaging device) in the first storage device for transmitting 12a. Further, the processing device 13 may read blocks of requested information that were transmitted from the external device or from the first storage device 12a and then transmit the blocks to the particular client apparatus (1 to n) that sent the transmit request. In addition, the processing device 13 may read requested blocks that will be retransmitted from the second storage device for retransmission 12b and then retransmit the blocks to the particular client apparatus (1 to n) that sent the retransmit request.

Depending on the application of the present teachings (e.g., the number of client apparatus or other such factors), a large-scale general purpose computer, mini-computer, workstation, personal computer, etc. may be used as the server 11. In the alternative, a dedicated server, such as a UNIX server, may be used as the server 11. In addition, the first storage device for transmitting 12a and the second storage device for re-transmission 12b may be a single, dual-purpose storage device. Further, although FIG. 2 shows a single server 11, a plurality of servers may be utilized.

According to the present teachings, the server 11 provides one representative example of an “information transmitting apparatus” and the client apparatus (1 to n) provide one representative example of an “information receiving apparatus.”

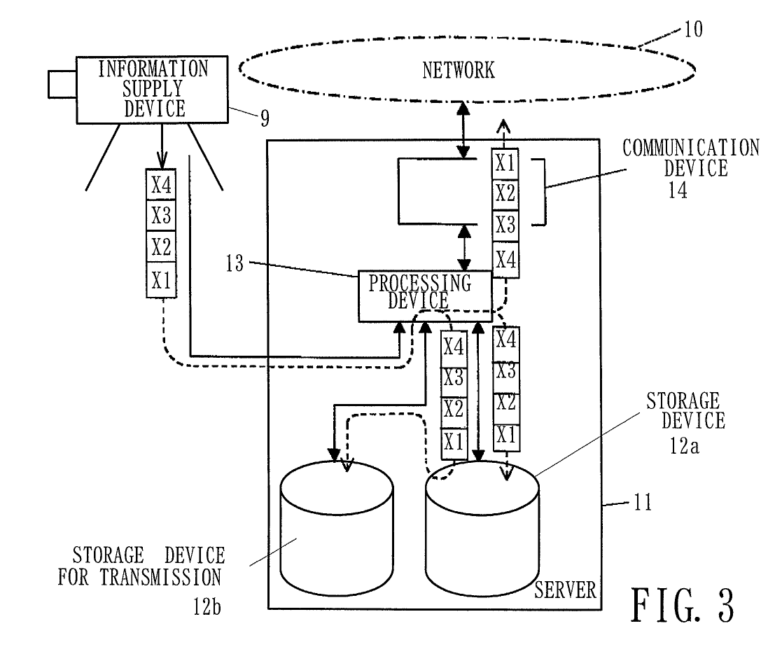

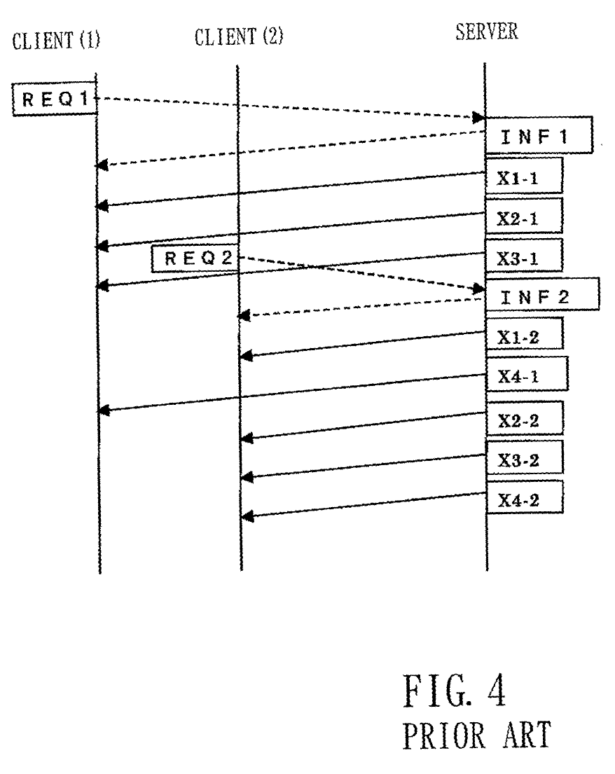

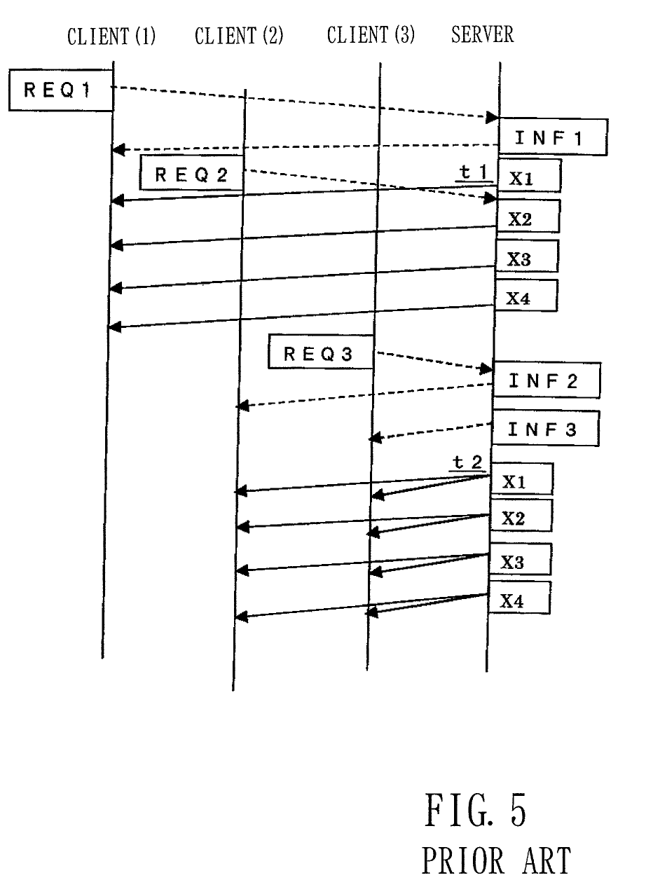

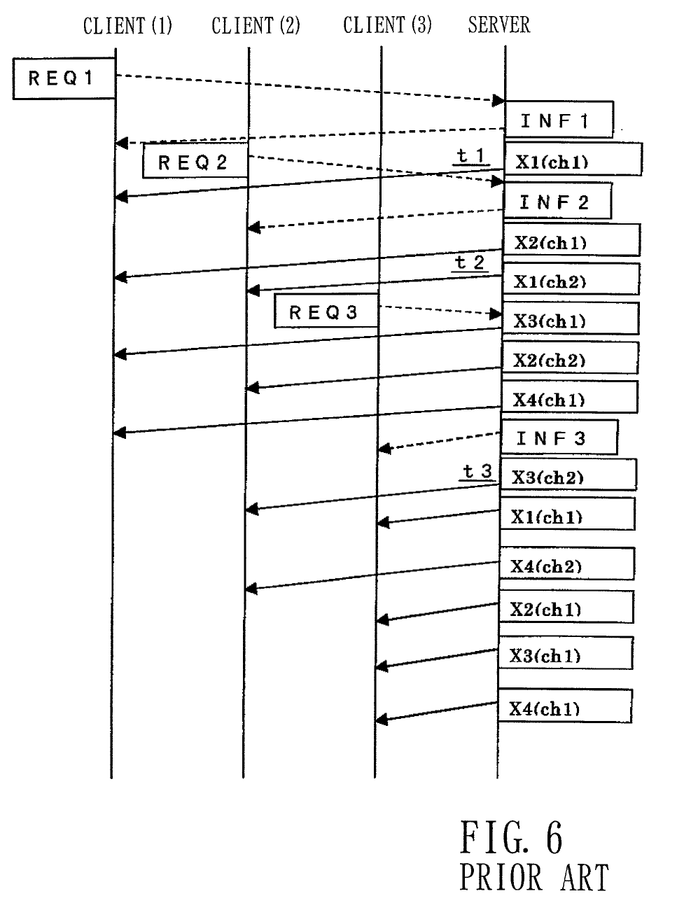

A representative method for transmitting the designated information (data) from the server 11 to client apparatus (1 to n) will now be described with reference to FIG. 3. For example, the information is preferably subdivided into a plurality of blocks or is regarded as being subdivided into a plurality of blocks. In this representative example, the designated information is subdivided into 4 blocks: X1, X2, X3 and X4. Moreover, the designated information can be later reconstituted by assembling blocks X1 to X4 in the sequence of X1, X2, X3, X4.

Each block may be, e.g., transmitted in packets. FIG. 14 shows a representative configuration for such packets. Thus, packet 20 may include an IP header portion 21 and an IP data portion 22. An IP address may be inserted into the IP header portion 21 in order to indicate the transmission destination of the packet 20. A group address that indicates a specific group (sub-network) may be set, for example, as the IP address.

IP data portion 22 may include, for example, subdivision sequence information, a block of data (subdivided from the designated information) and error detection/correction information. The subdivision sequence information preferably indicates which block within the sequence has been inserted into IP data portion 22. The block transmit sequence and the block assembly sequence are determined based on the subdivision sequence information. In addition, missing blocks can also be detected based on the subdivision sequence information. Error detection for the data inserted into the IP data portion 22 and error correction (in the case of a few errors) can be performed based on the error detection/correction information.

The processing device 13 preferably subdivides information that is supplied from an external device (e.g., an imaging device) or from an input device (e.g., a reading device that can read information stored in a storage medium) into blocks having a specific size (X1 to X4 in this embodiment). The blocks are then stored in the first storage device (storage device for transmitting) 12a. For example, as shown in FIG. 3, the processing device 13 preferably subdivides the information supplied from the information supply device 9 into blocks X1 to X4, and then stores the subdivided blocks X1 to X4 in the first storage device 12a. At this time, the sequence of blocks X1 to X4 is stored in an identifiable order. For example, the subdivision sequence information may also be stored in first storage device 12a. Alternatively, the blocks are stored in first storage device 12a in a fixed sequence.

In addition, the processing device 13 also preferably transmits blocks X1 to X4 of information supplied from an external device, or blocks X1 to X4 stored in the first storage device 12a, via the network 10. The processing device 13 also preferably processes the storage of blocks X1 to X4 in the second storage device for re-transmission 12b.

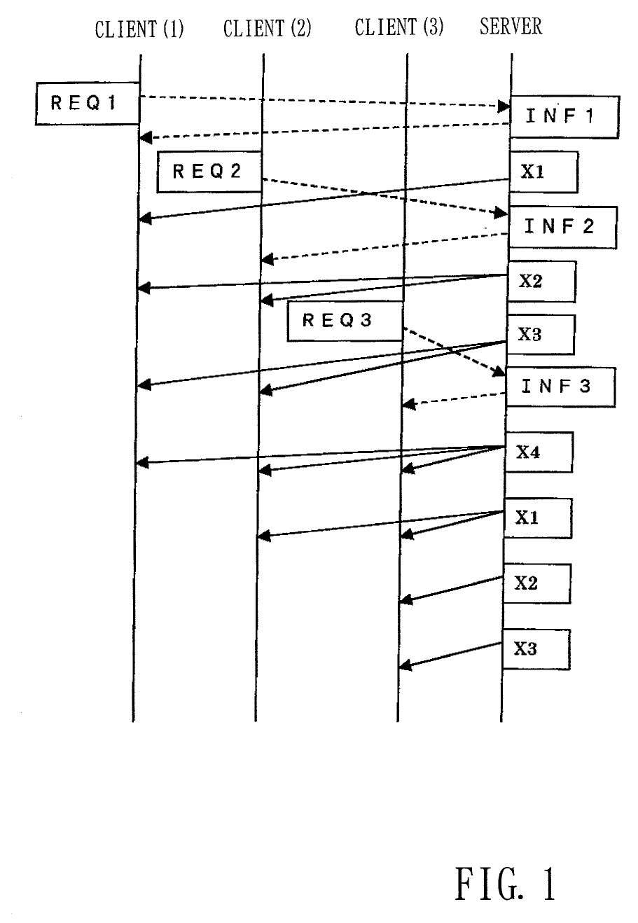

A representative method for transmitting information (blocks) stored in the first storage device 12a from the server 11 in response to transmit requests from client apparatus (1) to (3) will now be described with reference to FIG. 1. While the server 11 is in its initial state, a transmit request (dispatch request) REQ1, which requests transmission of certain designated information, is sent from client apparatus (1) to the server 11 via the network 10. In FIG. 1, transmissions that utilize the unicast method are indicated with broken lines having directional arrows.

In response to receiving a transmit request REQ1 from client apparatus (1), the server 11 (specifically, processing device 13) prepares to transmit using the multicast method. In particular, blocks X1 to X4 are preferably subdivided from the designated information. In other words, a group address is transmitted to client apparatus (1). This group address is necessary for receiving blocks X1 to X4, which are transmitted using the IP multicast method from the server 11. In this embodiment, group address INF1 is transmitted using the unicast method to client apparatus (1) that sent the transmit request REQ1. Further, a class D address is preferably selected from the IP addresses used in a TCP/IP communication system and is used as the address for group address INF1. A class D address is a special address that identifies the specified group.

Client apparatus (1) receives the group address INF1, which was transmitted from the server 11, and stores the received group address in the storage device 8 (see FIGS. 2 and 12) as the address of its own affiliated group. The server 11 then transmits to client apparatus (1) the total number (total count) of blocks (e.g., X1 to X4) that comprise the designated information. In this representative example, the server 11 notifies client apparatus (1) that a total of 4 blocks of information (data) will be transmitted. The data concerning the total number of blocks may be transmitted together with the group address INF1 or may be transmitted with each block. Client apparatus (1) stores the data concerning the total number of blocks in the receiving management table 5, as seen in FIG. 12.

Next, the server 11 reads block X1, which is the first block of the designated information, from the first storage device 12a. Then, a group address INF1 is specified and block X1 is transmitted via the network 10 by the communication device 14 using the multicast method. In FIG. 1, transmissions using the multicast method are indicated with solid lines having directional arrows.

When client apparatus (1) receives block X1 from the network 10, which block X1 includes the group address identified as its own group address INF1, client apparatus (1) stores block X1 in the storage device 8. At this time, client apparatus (1) also stores management information in the receiving management table 5. For example, the management information may include, e.g., the total number of blocks comprising the designated information, the identifying information that indicates the designated information, the subdivision sequence information of block X1 and/or the subdivision sequence information of an incorrectly received block. When the subdivision sequence information of an incorrectly received block is stored in the receiving management table 5 (see FIG. 12), a retransmit request (described further below) is sent to the server 11.

Before transmitting all blocks (X1 to X4) from the server 11 to client apparatus (1), for example during transmission of block X1, the server 11 may receive a transmit request REQ2 from client apparatus (2). In this case, the server 11 can use the unicast method to transmit the group address INF2 to client apparatus (2). At this time, in some cases, the same group address INF1 as client apparatus (1) is sent to client apparatus (2). Client apparatus (2) receives the group address INF2 transmitted from the server 11 and stores the group address INF2 in the storage device 8 as the group address of its own group.

The server 11 then reads block X2 from the first storage device 12a, which is the next sequential block after X1, and uses the IP multicast method to transmit block X2 via the network 10. At this time, the server 11 specifies group addresses INF1 and INF2 for block X2. In other words, regardless of whether block X2 will be sent to a plurality of client apparatus, the server 11 uses the IP multicast method to transmit a single block X2 via the network 10. When client apparatus (1) receives block X2 from the network 10, which block X2 includes the group address that is identical to its own group address INF1, client apparatus (1) stores block X2 in the storage device 8. Also, when client apparatus (2) receives block X2, which block X2 includes the group address that is identical to its own group address INF2, client apparatus (2) stores block X2 in its storage device 8.

Similarly, the server 11 reads block X3 from the first storage device 12a, which is the next sequential block after block X2, specifies group addresses INF1 and INF2 and then transmits block X2 via the network 10 by the communication device 14. When client apparatus (1) and client apparatus (2) receive block X3 from the network 10, which block X3 includes the group addresses that are identical to their own group addresses INF1 or INF2, client apparatus (1) and client apparatus (2) store block X3 in their respective storage devices 8. Moreover, while block X3 is being transmitted from the server 11, the server 11 may receive a transmit request REQ3 from client apparatus (3). In this case, the server 11 can use the unicast method to transmit a group address INF3 to client apparatus (3). When client apparatus (3) receives the group address INF3 that was sent from the server 11, client apparatus (3) stores the group address INF3 in its storage device 8 as its own group address.

The server 11 then reads block X4 from the first storage device 12a, which is the next sequential block after block X3, and specifies group addresses INF1, INF2 and INF3. Then, the server 11 uses the IP multicast method to transmit block X4 via the network 10. Client apparatus (1) to (3) receive block X4, which block X4 includes the group addresses that are identical to their own group addresses INF1, INF2 and INF3, and store block X4 in their respective storage devices 8.

At this time, the server 11 has completed the transmission of the designated information (blocks X1 to X4) to client apparatus (1). However, the transmission of the designated information (blocks X1 to X4) to client apparatus (2) and (3) has not yet been completed. Therefore, after transmitting block X4 specified with group addresses INF1, INF2 and INF3 using the multicast method, the server 11 continues transmitting blocks X1, X2 and X3. In other words, the server 11 specifies group addresses INF2 and INF3 for block X1 and then transmits block X1 via the network 10. Then, the server 11 specifies a group address INF3 for blocks X2 and X3 and transmits block X2 and X3 via the network 10.

As shown in the sequence diagram of FIG. 1, client apparatus (1) receives the designated information in the sequence of blocks X1, X2, X3, X4; client apparatus (2) receives the designated information in the sequence of blocks X2, X3, X4, X1; and, client apparatus (3) receives the designated information in the sequence of blocks X4, X1, X2, X3.

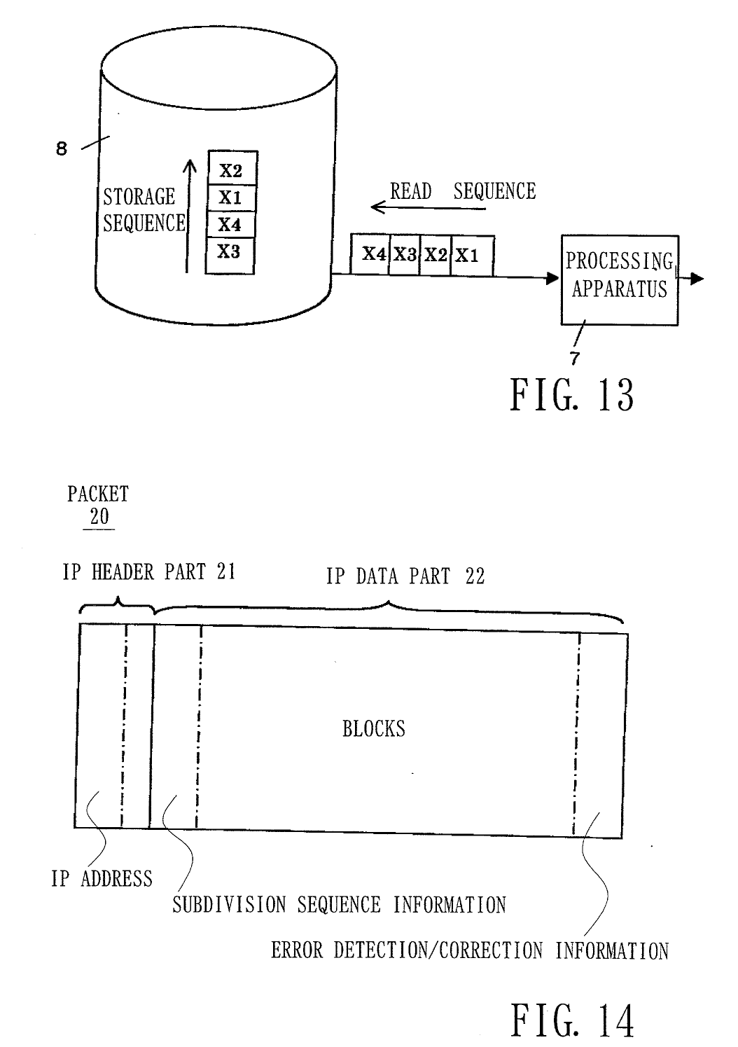

Further, the server 11 transmits packet 20, into which blocks X1 to X4 and the subdivision sequence information for each block have been inserted as shown in FIG. 14. Thus, each client apparatus (1) to (3) can use any appropriate method for storing each received block X1 to X4 in their respective storage devices 8. For example, as shown in FIG. 13, each block X1 to X4 can be stored in the storage device 8 in the sequence that it was received. In FIG. 13, blocks X1 to X4 are received in the sequence of X3, X4, X1, X2, and are stored in the storage device 8 in the received order. In this case, the processing device 7 of the client apparatus reads blocks X1 to X4 stored in the storage device 8 with reference to the subdivision sequence information of each block X1 to X4. Moreover, the processing device 7 reconstitutes the designated information by re-combining blocks X1 to X4 with reference to the subdivision sequence information of each block. Of course, the received blocks X1 to X4 can also be stored in the storage device 8 according to the subdivision sequence information of each block.

As described above, while the server 11 is transmitting the designated information (blocks) to one or more client apparatus, the server 11 will repeatedly transmit blocks X1 to X4 in a fixed sequence (playback sequence) via the network 10 using the multicast method, as long as requests to transmit the information continue to be sent from other client apparatus. When the server 11 receives a transmit request from one or more client apparatus in its initial state, the server 11 will begin to transmit the plurality of blocks that comprise the designated information (data) in sequence starting from the first block. Moreover, prior to completing the transmission of the designated information (blocks that comprise the designated information) to the client apparatus that sent the transmit request, the server 11 will start to transmit the blocks to other client apparatus in sequence starting with the block being transmitted at that time, if the server 11 receives a request to transmit the information from another client apparatus (either from a single apparatus or a plurality of apparatus).

When transmitting blocks X1 to X4 from the server 11 via the network 10 using the multicast method, setting of network 10 is not performed. Therefore, blocks X1 to X4 are transmitted from the server 11 using the multicast method and are transferred to all areas of the network 10. Therefore, as the area of the network 10 becomes broader, the transfer efficiency deteriorates and the quantity of data on the network increases.

Thus, the network 10 is preferably set such that blocks X1 to X4, which are transmitted from the server 11 using the multicast method, will efficiently reach the client apparatus that sent the transmit request. For example, in response to receiving a transmit request REQ1 from client apparatus (1), the server 11 sets the network 10 such that blocks X1 to X4 will reach the group that includes the client apparatus (1) that sent the transmit request REQ1. That is, the server 11 sends to the router in the network 10 the required information for transmitting blocks X1 to X4 to client apparatus (1) using the IP multicast method. This information is used to set the network 10 so that client apparatus (1) can receive blocks from the router in the network 10, when blocks X1 to X4 are transmitted from the server 11 via the network 10 using the IP multicast method.

In this specification, the required information (for example, the network setting information and the group addresses INF1 to INF3) for receiving information transmitted using the IP multicast method may be referred to as “required transmitting information” or “required receiving information.”

If information (blocks of data) is transmitted using the IP multicast method to a class D IP address (group address), it is not necessary for the server 11 to specify the IP addresses for individual client apparatus when transmitting the information. In other words, the server 11 may specify the group address and transmit blocks via the network 10 one time. In this case, a plurality of client apparatus affiliated with the group specified by the group address can receive the block transmitted via the network 10. Of course, each node (not shown) and each router (not shown) in the network 10 must be adapted to use the IP multicast method.

Further, the first storage device 12a, which stores information (blocks X1 to X4), may be provided internally within the server 11, or may be provided externally to the server 11. If the information (blocks X1 to X4) is stored in a first storage device 12a that is provided internally in the server 11, it is preferable to store blocks X1 to X4 subdivided from the information and the subdivision sequence information.

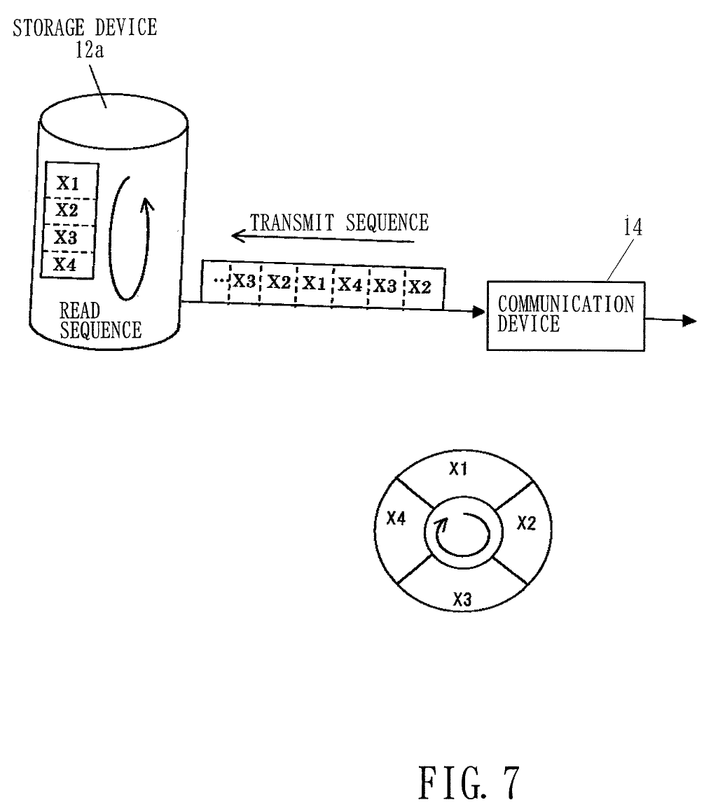

FIG. 7 shows a representative method for operating the server 11 of this representative embodiment in order to transmit designated information (blocks). Blocks X1 to X4, which comprise the designated information (data), are stored in the sequence of X1, X2, X3, X4 in the first storage device (storage device for transmitting) 12a of the server 11. The processing device 13 (see FIG. 2) reads blocks X1 to X4 from the first storage device 12a in the specified sequence. For example, the processing device 13 reads block X1 first, block X2 second, block X3 third, and block X4 fourth. Then, returning to the top of the block sequence, the processing device 13 reads block X1fifth. Thus, the processing device 13 continues to cyclically read blocks X1 to X4. Blocks X1 to X4 read from the storage device 12a are sent to the communication device 14. The communication device 14 transmits blocks X1 to X4 via the network 10. The transmitting sequence for blocks X1 to X4 may be X2, X3, X4, X1, X2, X3, etc. While transmitting the information from the server 11, the server 11 continues the cyclic transmitting operation in the specified sequence shown in FIG. 7, as long as the server 11 continues to receive requests to transmit the information (data) from one or more client apparatus.

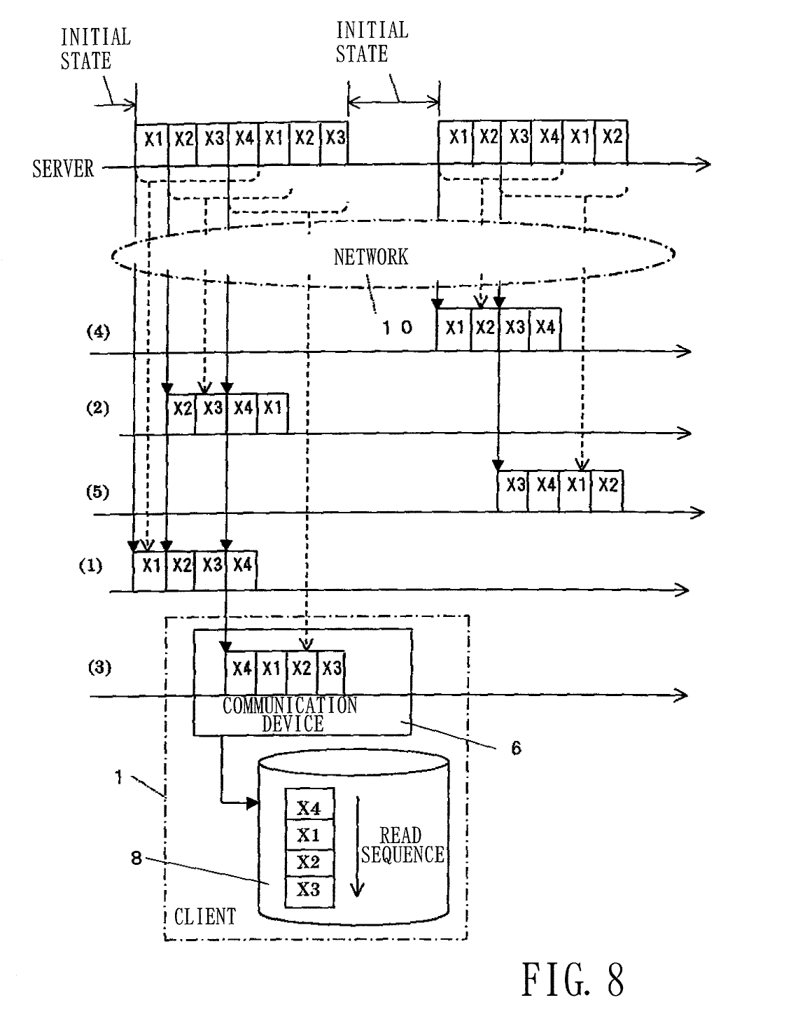

FIG. 8 shows in further detail a sequence diagram describing a representative operation for sending requests to transmit the designated information. The server 11 is in its initial state when it has not received transmit requests from the client apparatus and is not transmitting information (blocks of data). When the server 11 receives a transmit request from client apparatus (1) in its initial state, the server 11 reads blocks X1 to X4, which comprise the requested information (data), from the first storage device 12a starting with the leading block in the block sequence. Then, the server 11 sequentially transmits blocks X1 to X4 via the network 10 using the multicast method. In other words, in response to receiving the transmit request from client apparatus (1), the server 11 starts transmitting blocks X1 to X4, which contain the designated information requested to be transmitted.

While blocks X1 to X4 are being transmitted to client apparatus (1), the server 11 will transmit the next sequential block to client apparatus (1) and to another client apparatus that has sent a transmit request, if the server 11 receives a request to transmit the designated information sent from another client apparatus. For example, while transmitting block X1 to the group affiliated with client apparatus (1), the server 11 will transmit the next block X2 to the group of the client apparatus affiliated with client apparatus (1) and (2), if the server 11 receives a transmit request from client apparatus (2). Moreover, while transmitting the next block X3 to the group of the client apparatus affiliated with client apparatus (1) and (2), the server 11 will transmit the next block X4 to the group of the client apparatus affiliated with client apparatus (1), (2), and (3), if the server 11 also receives a transmit request from client apparatus (3).

In summary, when blocks X1 to X4 comprising the designated information from the sequence X1, X2, X3, X4, the sequence of blocks transmitted from the server 11 via the network 10 using the IP multicast method will be X1, X2, X3, X4, X1, X2, X3, X4, etc. While transmitting the designated information (blocks), this cycle (i.e., X1, X2, X3, X4) will be repeated as long as the server 11 continues to receive requests to transmit the designated information. In the embodiment shown in FIG. 8, client apparatus (1) and the client apparatus (4) receive blocks in the sequence of X1, X2, X3, X4; client apparatus (2) receives blocks in the sequence of X2, X3, X4, X1; client apparatus (3) receives blocks in the sequence of X4, X1, X2, X3; and, client apparatus (5) receives blocks in the sequence of X3, X4, X1, X2.

A representative method for transmitting information (blocks) stored in the first storage device 12a was described above. Therefore, a representative method for supplying information from an external device (e.g., information supply apparatus 9, which may be an imaging device) will now be described with reference to FIG. 3. In this case, prior to the start time (i.e., when the information supply device 9 will begin supplying information), at least one client apparatus has sent a request to transmit information from the information supply device 9 to the server 11. Therefore, at the information supply start time (for example, at the start time of a live broadcast), the information supply device 9 sequentially transmits blocks X1 to X4, which comprise the designated information, to the server 11 in the sequence of X1, X2, X3, X4. The processing device 13 of the server 11 stores blocks X1 to X4 sent from the information supply apparatus 9 in the first storage device 12a (storage device for transmitting).

At this time, blocks X1 to X4, which were sent from the information supply device 9, may also be stored in the second storage device 12b (storage device for re-transmitting). In this case, blocks X1 to X4 can be read from the second storage device 12b if re-transmission is requested (described further below).

Moreover, while the processing device 13 is storing blocks X1 to X4 received from the information supply device 9 in the first storage device 12a, the processing device 13 simultaneously or nearly simultaneously transmits the blocks via the network 10 using the multicast method by the communication device 14. In other words, if the start time for supplying information (blocks X1 to X4) from the information supply device 9 is predetermined, and if a request to transmit the information is received from a client apparatus prior to the supply start time, the server 11 will transmit the information supplied from the information supply device 9 (blocks X1 to X4) via the network 10 and also store the information in the first storage device 12a.

Information supplied from the information supply device 9 is transmitted via the network 10 in a one-time process performed when blocks X1 to X4 arrive. During or after transmission of new information supplied from the information supply device 9 via the network 10, if a request to transmit information is received from another client apparatus (1 to n), the server 11 will continue to read the information from the first storage device 12a and transmit the information via the network 10 after completing the transmission of the new information.

As discussed above, block errors may occur in blocks transmitted from the server 11. For example, while blocks X1 to X4 transmitted from the server 11 are being transferred over the network 10, data in blocks X1 to X4 may drop out or may change (e.g., be corrupted during transmission). Or, in some cases, client apparatus (1 to n) may not be able to receive blocks X1 to X4 transmitted from the server 11. Although an error may be detected using the subdivision sequence information, it may be difficult to correct the error using the subdivision sequence information. Therefore, error detection/correction information is preferably appended to the blocks and is separate from the subdivision sequence information. Therefore, when blocks X1 to X4 are transmitted, the server 11 appends block error detection/correction information to each block X1 to X4, as shown in FIG. 14.

For example, an ECC code, such as the Reed-Solomon code, may be used as the block error detection/correction information. By appending such a block error detection/correction code to the blocks, the client apparatus can detect missing or changed data in a received block. Moreover, if the extent of the missing or changed data is relatively small, the correct data can be reconstituted by performing error correction. On the other hand, if there is a large amount missing or changed data, such that the correct data can not be reconstituted by performing error correction, the client apparatus (1 to n) can request the server 11 to retransmit the block.

A variety known techniques may be utilized to generate the error detection/correction information. For example, parity bit information, BCH coding, RS coding, or other similar techniques may be utilized. BCH and RS codes are used to detect and correct erroneous bits in situations in which a plurality of bit errors have occurred in data comprised of a plurality of bits. By utilizing block error detection/correction information, error correction will enable the data to be processed correctly, in the event that there is only a small amount of missing or changed data. As a result, the number of retransmissions can be decreased and the quantity of data on the network 10 can be reduced.

A representative method for operating client apparatus (1 to n) when receiving information (blocks of data) will be described now with reference to FIG. 2. Client apparatus (1 to n) receive blocks from the network 10 and the group address for the blocks of data are identical to the group address of the client apparatus. Client apparatus (1 to n) then perform error detection based upon the subdivision sequence information or block error detection/correction information that was received together with the block. For example, communication device 6 and/or processing device 7 may process errors (see FIG. 12).

One representative method for performing error detection will be described next. For example, non-received blocks can be detected by referencing the subdivision sequence information. Thus, if the subdivision sequence information is not consecutive, the block corresponding to the missing subdivision sequence information is detected as having not been received. In this case, information specifying the non-received block (e.g., information that identifies the designated information and the subdivision sequence information) is stored in the receiving management table 5.

Further, if information related to the data size of the block is also included in the subdivision sequence information, it is possible to detect whether all the data of the block has been correctly received by referencing the subdivision sequence information. If all the data of the block was not correctly received, information specifying the block (e.g., identifying information that identifies the designated information and a subdivision sequence information) is stored in the receiving management table 5.

Based upon the block error detection/correction information that is received together with the block, error detection and error correction for a received block can be performed. For example, if an error has been detected in a received block, error correction is performed when possible. If error correction is not possible, information specifying the block for which error correction is not possible (e.g., identifying information that identifies the designated information and subdivision sequence information) is stored in the receiving management table 5.

Based upon the information stored in the receiving management table 5, the client apparatus (1 to n) will send one or more retransmit requests to the server 11. The operation for re-transmitting a block of the server 11 in response to receiving a retransmit request will be described further below.

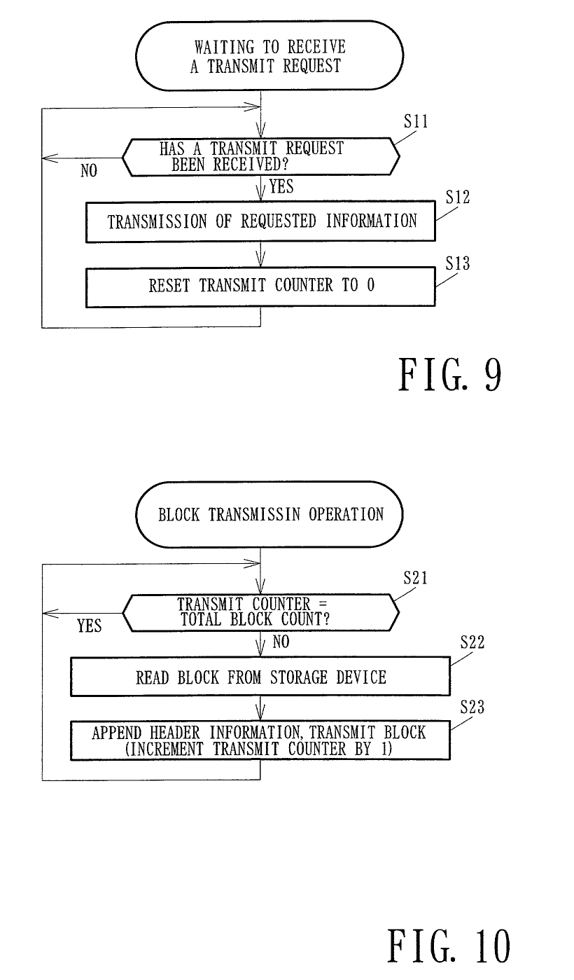

A representative method for operating the server 11 will now be described. Preferably, the server 11 can simultaneously perform the following operations in parallel: wait for receiving transmit requests, transmit blocks, and retransmit blocks. A representative example showing the server 11 waiting for receiving transmit requests will be described with reference to the flowchart illustrated in FIG. 9.

First, in step S11, the server 11 determines whether a transmit request has been received from one or more client apparatus (1 to n). If the server 11 can transmit a plurality of information, client apparatus (1 to n) send transmit requests that include identifying information that identifies the information requested to be transmitted, or send transmit requests corresponding to the information requested to be transmitted. If a transmit request has not been received (i.e., “NO” in Step S11), the server 11 continues to wait. However, if a transmit request has been received (i.e., “YES” in Step S11), the process proceeds to step S12.

In step S12, the required information (such as group addresses, and the total number of blocks of information to be transmitted) for information (block) reception is transmitted using the unicast method to the particular client apparatus that sent the transmit request. At the same time, the total block count is stored. Next, in step S13, the transmit counter is reset to 0 so as to start the operation for transmitting blocks via the network 10. Thereafter, whenever a transmit request is received from any client apparatus (1 to n), the transmit counter is reset to 0.

A representative method for operating the server 11 when transmitting information (blocks) via the network 10 will now be described with reference to the flowchart shown in FIG. 10. First, in step S21, the server determines whether the value stored in the transmit counter equals the total block count. If the transmit counter value equals the total block count (i.e., “YES” in Step S21), the server 11 continues to wait. However, if the transmit counter value does not equal the total block count (i.e., “NO” in Step S21), the process proceeds to step S22. In step S22, the sequential block indicated by the read block pointer is read from the storage device 12a.

Next, in step S23, information such as the group address, subdivision sequence information, error detection/correction information, and information identifying the information to be sent is appended to the read block. Then, the block is transmitted via the network 10 using the multicast method. At the same time, the transmit counter is incremented by 1. Also, the block pointer is set to the point indicating the next block to be transmitted. For example, the block pointer is set to correspond to the subdivision sequence information. For usual transmissions, the block pointer may be incremented by 1. However, in the case of retransmissions, the block pointer is set to a value corresponding to the sequential order of the next block to be retransmitted.

When the total number of transmitted blocks equals the total block count, “YES” is indicated in step 21. In other words, the block transmission process continues when the value of the transmit counter does not equal the total block count. Further, the block transmitting process stops when the transmit counter becomes equal to the total block count.

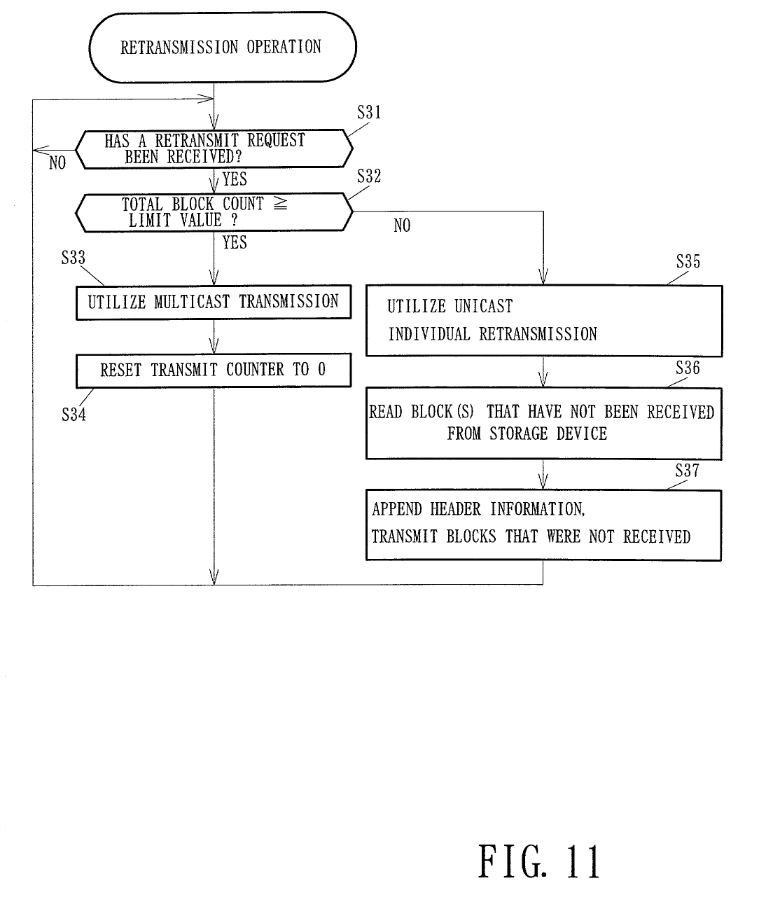

A representative method for re-transmitting blocks from the server 11 will now be described with reference to the flowchart shown in FIG. 11. In step S31, the server 11 determines whether a retransmit request has been received from a client apparatus (1 to n). If a retransmit request has not been received (i.e., “NO” in Step S31), the server 11 continues to wait. However, if a retransmit request has been received (i.e., “YES” in Step S31), the process proceeds to step S32. Client apparatus (1 to n) send retransmit requests, which include information (e.g., an identifying information and an subdivision sequence information) specifying a block that has not been received, to the server 11. For example, one or more blocks may not have been received.

In step S32, the server 11 calculates the total number of blocks (total block count) transmitted via the network 10 per unit time, if blocks requested to be retransmitted are individually retransmitted. Then, the server 11 determines whether the total block count exceeds the limit value. If the total block count exceeds the limit value, the process proceeds to step S33. If the total block count does not exceed the limit value (i.e., “NO” in Step S32), the process proceeds to step S35.

In step S33, the server 11 determines to retransmit the blocks using the multicast method. In other words, due to a relatively large total number of blocks requested to be retransmitted (which will place a large load on the network), the blocks are preferably retransmitted using the multicast method. Therefore, the server 11 notifies the client apparatus that sent the retransmit request that the retransmission will be performed using the multicast method. For example, the server 11 notifies the client apparatus of the group address.

Next, in step S34, the transmit counter is reset to 0. As a result, “NO” is indicated in step S21 (FIG. 10) and the retransmission of the blocks requested to be retransmitted is started using the multicast method.

However, in step S35, the server 11 determines to retransmit the blocks using the unicast method. In other words, due to a relatively small total number of blocks requested to be retransmitted (which will not overly load the network), the server elects to retransmit the blocks using the unicast method. Therefore, the server 11 notifies the client apparatus, which sent the retransmit request, that the retransmission will be performed using the unicast method. In step S36, the server 11 reads the blocks that were not received by the client apparatus that sent the retransmit request. Then, in step S37, data identifying information, subdivision sequence information, and error detection/correction information are appended to the blocks, and the blocks are retransmitted using the unicast method to the client apparatus that sent the retransmit request.

As described further above, this representative embodiment includes the second storage device for re-transmission 12b in addition to the first storage device (storage device for transmitting) 12a. Information (blocks) transmitted from an external or another device is stored in the first storage device for transmitting 12a and the second storage device for re-transmission 12b. In the alternative, blocks stored in the first storage device for transmitting 12a may be stored in the second storage device for re-transmission 12b when a retransmission process is performed. Blocks to be retransmitted may be read from the second storage device for re-transmission 12b, and then transmitted to the client apparatus that sent the retransmit request. Of course, blocks to be transmitted and blocks to be retransmitted may both be stored in the first storage device 12a. Moreover, a block stored in the first storage device 12a may be read, transmitted and retransmitted.

In this representative embodiment, the server 11 determines whether to retransmit the blocks using the unicast method or the multicast method based upon the total number of blocks requested to be retransmitted (blocks not received) by the client apparatus. Of course, in response to retransmit requests from the client apparatus, the server 11 may exclusively use the unicast method or exclusively use the multicast method. In addition, the server 11 can determine the quantity of data on the network 10 per unit time, and based on the quantity of data on the network 10, the server 11 can control (band limiting control) the number of blocks to be transmitted via the network 10. As a result, the quantity of data on the network 10 can be suitably regulated and degradation of the transfer efficiency can be avoided.

The following representative advantageous effects may be obtained by utilizing the present teachings. The load on the server and the network can be reduced by providing (1) a server apparatus that uses the multicast method to transmit a block once via the network and (2) a client apparatus that receives blocks in sequence, beginning with the block that the client apparatus can receive at that time. Further, while the server is transmitting the designated information to a certain client apparatus, if there is a request to transmit the information from another client apparatus, the other client apparatus can receive the information within a short wait time.

In addition, when the server is required to re-transmit a certain block, the load on the network can be minimized by simultaneously performing the retransmission process and the normal transmission processes. In other words, when the server receives a retransmit request for an arbitrary block from an arbitrary client apparatus, the server simultaneously transmits the block to the client apparatus that sent a usual transmit request and to the client apparatus that sent the retransmit request. If re-transmission process is performed as a part of the usual transmitting process, the load on the network will not increase, even if the number of required re-transmissions increases.

Naturally, a variety of other modifications, additions, and deletions are possible for the present teachings. For example, although the subdivision sequence information of each block is transmitted in the above representative embodiment, it is not required to always transmit the subdivision sequence information of each block. For example, if the total number of blocks that comprise the information, the first block, and the last block are known, it is possible to reconstitute the information.

Further, although the representative embodiment utilized a single server, it is also possible to utilize a plurality of servers. Moreover, although the representative embodiment concerned a client-server communication system, the present teachings also can be employed in other types of communication systems. In addition, the method for setting the group affiliation of each client apparatus can be changed as desired. For example, instead of determining the group address of a client apparatus whenever a transmit request has been received from the client apparatus, it is also acceptable to pre-set the group address of each client apparatus in advance. In this case, the transmission of a group address from the server to each client apparatus is not necessary.

In sum, a list of some of the functions of both the sever 11 and clients 1 is provided:

### Certain Functions Provided By Client 1 (i.e., Information Receiving Apparatus)

(1) sends a transmit request for transmitting the designated information (content);

(2) receives the blocks subdivided from the designated information by using the multicast method by the communication device;

(3) stores each block in the storage device with the subdivision sequence information;

(4) reads each block from the storage device with reference to the subdivision sequence information;

(5) detects the error (missing block) by using the subdivision sequence information or the error detection/correction information;

(6) stores the management information in the receiving management table;

(7) sends a retransmit request for retransmitting blocks;

### Certain Functions Of The Server 11 (i.e., The Information Transmitting Apparatus)

(1) transmits the designated information (content) in response to receiving a request for transmitting the designated information from the client (the information receiving apparatus);

(2) transmits the information by using the IP multicast method by the communication device;

(3) transmits blocks subdivided from the designated information (content);

(4) cyclically transmits the blocks as long as requests for transmitting the designated information are received from information receiving apparatuses prior to transmitting all blocks comprising the designated information;

(5) stores blocks subdivided from the information (content) in the storage device;

(6) reads blocks from the storing device and transmits blocks;

(7) transmits blocks together with a subdivision sequence information;

(8) appends the error detection/correction information to each block;

(9) sets the network;

(10) controls the bandwidth (quantity of data transmitted from the client per unit time);

(11) transmits information (content) supplied from an external device;

(12) retransmits information in response to receiving a retransmit request;

(13) retransmits information by using IP multicast method;

(14) retransmits information by using unicast method;

(15) selects a retransmission method based upon the status of the network.

The following table shows the components used in a presently preferred embodiment:

| | Kind of | |
|---|---|---|
| | Products | Name of Products |
| Devices for CLIENT | | |
| STORAGE DEVICE 8 | IDE-HDD | Integrated Hard Disk Drive |
| | | TOSHIBA MK2016GAP |
| COMMUNICATION | LAN | Intel 8255x-based Integrated |
| DEVICE 6 | Interface | Fast Ethernet |
| PROCESSING DEVICE 7 | CPU | Intel PentiumIII 600 MHz |
| RECEIVING | MEMORY | Integrated SDRAM |
| MANAGEMENT | | |
| TABLE 5 | | |
| CLIENT APPARATUS | PC | Panasonic CF-B5R |
| Devices for SERVER | | |
| STORAGE DEVICE 12a | IDE-HDD | Maxtor 5T010H1 |
| (First storage device for | | |
| transmitting) | | |
| STORAGE DEVICE 12b | IDE-HDD | Same as above |
| (Second storage device for | | |
| re-transmitting) | | |
| INFORMATION SUPPLY | Video | Conexant FUSION 878A |
| DEVICE 9 | Capture | |
| COMMUNICATION | LAN | Intel i82557/i82558 10/100 |
| DEVICE 14 | Interface | Ethernet |
| PROCESSING DEVICE 13 | CPU | Intel PentiumIII 800 MHz |
| SERVER APPARATUS | PC | DELL PowerEdge SC300 |

1. An apparatus comprising:
a first information receiving apparatus having a first group address,
a second information receiving apparatus having a second group address, and
an information transmitting apparatus in communication with the first and second information receiving apparatus via a network, the information transmitting apparatus being arranged and constructed to (1) transmit via the network two or more blocks of data subdivided from a designated information together with the first group address for the first information receiving apparatus in response to receiving a request to transmit the designated information from the first information receiving apparatus, (2) transmit via the network one ore more blocks of data that have not yet been transmitted to the first information receiving apparatus with the first group address and the second group address for the second information receiving apparatus, in response to receiving a request to transmit the designated information from the second information receiving apparatus prior to transmitting all blocks of data, which contain the designated information, to the first information receiving apparatus, and (3) transmit via the network one or more blocks of data already transmitted to the first receiving apparatus with the second group address, wherein the first and second information receiving apparatus are further arranged and constructed to send the request to transmit the designated information to the information transmitting apparatus, receive blocks of data via the network, wherein the group address of the received blocks of data are identical to the respective group addresses, and store the received blocks of data in a storage device.

2. An apparatus according to claim 1, wherein the information transmitting apparatus is arranged and constructed to transmit each block of data with the subdivision sequence information indicating the sequence of each block of data, and the first and second information receiving apparatus are arranged and constructed to reconstitute the information based upon the received blocks of data and the subdivision sequence information of each block of data.

3. An apparatus according to claim 1, wherein the information transmitting apparatus is arranged and constructed to cyclically transmit the blocks of data subdivided from the designated information apparatus in a predetermined sequence, when the information transmitting apparatus receives another request to transmit the designated information from another information receiving apparatus prior to transmitting all blocks of data subdivided from the designated information.

4. An apparatus according to claim 1, wherein the information transmitting apparatus further comprises a storage device for storing blocks of data, wherein the information transmitting apparatus is further arranged and constructed to read blocks of data from the storage device in a predetermined sequence and transmit blocks of data via the network.

5. An apparatus according to claim 1, further comprising an information supply device arranged and constructed to supply information, wherein the information transmitting apparatus is arranged and constructed to transmit via the network each block of data subdivided from the information supplied from the supplying device together with a subdivision sequence information indicating the sequence of each block of data.

6. An apparatus according to claim 5, wherein the information transmitting apparatus is further arranged and constructed to (1) store each block of data and a subdivision sequence information of each block of data in a storage device in the predetermined sequence, (2) read each block of data and the subdivision sequence information from the storage device in the predetermined sequence and (3) transmit each block of data and the subdivision sequence information via the network in response to receiving a transmit request for the designated information supplied by the information supply apparatus.

7. An apparatus according to claim 5, wherein the information transmitting apparatus is further arranged and constructed to (1) store each block of data and a subdivision sequence information of each block of data in a storage device, (2) read each block of data and the subdivision sequence information from the storage apparatus in the sequence specified by the subdivision sequence information and (3) transmit each block of data and the subdivision sequence information via the network in response to receiving a request for the designated information supplied from the information supply apparatus.

8. An apparatus according to claim 1, wherein the information transmitting apparatus is further arranged and constructed to append error detection/correction information to each block of data and transmit each block of data, and the first and second information receiving apparatus are further arranged and constructed to perform error detection and error correction based upon the appended error detection/correction information received together with the block of data.

9. An apparatus according to claim 2, wherein the first and second information receiving apparatus are further arranged and constructed to determine whether each block of data has been correctly received based upon the subdivision sequence information within each block of data.

10. An apparatus according to claim 1, wherein the first information receiving apparatus is arranged and constructed to transmit a request to retransmit a block of data to the information transmitting apparatus, and the information transmitting apparatus is arranged and constructed to retransmit the requested block of data to the first information receiving apparatus upon receiving the request to retransmit request, the first information receiving apparatus being further arranged and constructed to receive and store the retransmitted block of data from the information transmitting apparatus.

11. An apparatus according to claim 10, wherein the information transmitting apparatus further comprises:
a first storage device for storing blocks of data that will be transmitted, and
a second storage device for storing blocks of data that will be retransmitted, wherein the information transmitting apparatus is arranged and constructed to read blocks of data from the first storage device after receiving a transmit request, and to read blocks of data from the second storage device after receiving a retransmit request.

12. An apparatus according to claim 10, wherein the information transmitting apparatus is further arranged and constructed to transmit via the network all blocks of data, which contain the designated information including the block of data requested to be retransmitted, in response to receiving a retransmit request for at least one block of data.

13. An apparatus according to claim 10, wherein the information transmitting apparatus is arranged and constructed, in response to receiving a retransmit request from the first or second information receiving apparatus, to determine whether to specify the address of the respective information receiving apparatus that sent the retransmit request or to specify the group address previously set for the respective information receiving apparatus that sent the retransmit request as the address of the block of data requested to be retransmitted, based on an evaluated result of bandwidth utilization status of the network.

14. An apparatus according to claim 13, wherein the information transmitting apparatus is further arranged and constructed to evaluate the bandwidth utilization status of the network based upon a comparison of a limit value and the number of blocks of data requested to be retransmitted.

15. An apparatus according to claim 13, wherein the information transmitting apparatus is further arranged and constructed to inform the first information receiving apparatus, which has sent a request to retransmit, of the evaluated result, and the first information receiving apparatus is further arranged and constructed to select a transmission method for receiving the block of data, which was requested to be retransmitted, based upon the evaluated result provided by the information transmitting apparatus.

16. An apparatus according to claim 1, wherein the information transmitting apparatus is further arranged and constructed to regulate the number of blocks of data transmitted via the network such that th e quantity of data on the network per unit time does not exceed a predetermined quantity.

17. An apparatus according to claim 1, wherein the information transmitting apparatus is arranged and constructed, in response to receiving a transmit request from the first or second information receiving apparatus, to transmit the group address for the first or second information receiving apparatus to the first or second information receiving apparatus, and the first and second information receiving apparatus are arranged and constructed to store the group address transmitted from the information transmitting apparatus as its own group address.

18. An apparatus according to claim 1, wherein the information transmitting apparatus is further arranged and constructed, in response to receiving a transmit request from the first or second information receiving apparatus, to set the network, wherein blocks of data transmitted from the information transmitting apparatus will arrive at the first or second information receiving apparatus.

19. A method for communicating information comprising:
transmitting a request for designated information from a first information receiving apparatus to an information transmitting apparatus,
transmitting the requested designated information from the information transmitting apparatus to the first information receiving apparatus in response to receiving the request to transmit the designated information, wherein the designated information is subdivided into blocks of data and the blocks of data are sequentially sent to the first information receiving apparatus, and wherein each block of data further includes a first group address corresponding to the first information receiving apparatus,
transmitting another request for the designated information from a second information receiving apparatus to the information transmitting apparatus,
transmitting blocks of data not yet transmitted to the first information receiving apparatus together with the first group address and a second group address corresponding to the second information receiving apparatus in response to receiving the transmit request from the second information receiving apparatus, wherein a middle block of data is first sent to the second information receiving apparatus prior to all blocks of data having been sent to the first information receiving apparatus, and
transmitting blocks of data with only the second group address that were previously transmitted to the first information receiving apparatus, wherein less than all blocks of data are transmitted with only the second group address.

20. A method according to claim 19, further comprising transmitting each block of data with subdivision sequence information, which subdivision sequence information enables the first and second information receiving apparatus to reconstitute the blocks of data into the designated information.

21. A method according to claim 19, further comprising cyclically transmitting each block of data subdivided from the requested information in a predetermined sequence as long as requests to transmit are received from information receiving apparatus prior to transmitting all blocks of data that comprise the requested information.

22. An apparatus for communicating information comprising:
means for transmitting a request for designated information from a first information receiving apparatus to an information transmitting apparatus,
means for transmitting the requested designated information from the information transmitting apparatus to the first information receiving apparatus in response to receiving the request to transmit the designated information, wherein the designated information is subdivided into blocks of data and the blocks of data are sequentially sent to the first information receiving apparatus, and wherein each block of data further includes a first group address corresponding to the first information receiving apparatus,
means for transmitting another request for the designated information from a second information receiving apparatus to the information transmitting apparatus,
means for transmitting blocks of data not yet transmitted to the first information receiving apparatus together with the first group address and a second group address corresponding to the second information receiving apparatus in response to receiving the transmit request from the second information receiving apparatus, wherein a middle block of data is first sent to the second information receiving apparatus prior to all blocks of data having been sent to the first information receiving apparatus, and
means for transmitting blocks of data with only the second group address that were previously transmitted to the first information receiving apparatus, wherein less than all blocks of data are transmitted with only the second group address.

23. A method for communicating information over a network comprising:
dividing data for distribution over said network into sequentially ordered X blocks;
receiving a first dispatch request seeking said data from a first client;
transmitting a first group address via said network to said first client;
sequentially transmitting each of said X blocks, commencing with a first block of said X blocks, to said first client;
receiving a second dispatch request seeking said data from a second client;
transmitting a second group address via said network to said second client;
sequentially transmitting all remaining blocks of said X blocks that have not yet been sent to said first client to said first client and said second client; and
starting with said first block, sequentially transmitting all of said X blocks which have not yet been sent to said second client.

24. The method of claim 23 wherein said sequentially transmitting each of said X blocks step and said sequentially transmitting all remaining blocks of said X blocks steps further comprises appending sequence information into each of said X blocks.

25. The method of claim 23 wherein said sequentially transmitting each of said X blocks step and said sequentially transmitting all remaining blocks of said X blocks steps further comprise appending error correction information into each of said X blocks.

26. The method of claim 25 further comprising:
receiving a retransmit request from at least one of said first client and said second client, said retransmit request containing information regarding which of said X blocks that must be retransmitted; and
determining whether the number of said X blocks that must be retransmitted exceeds a predetermined value.

27. The method of claim 26 wherein the number of said X blocks that must be retransmitted is equal to or greater than said predetermined value, further comprising:
transmitting a third group address via said network; and
transmitting said X blocks that must be retransmitted via said network.

28. The method of claim 26 wherein the number of said X blocks that must be retransmitted is less than said predetermined value, further comprising:
establishing a communication connection in said network with whichever of said first client and/or said second client that sent said retransmit request; and
transmitting said X blocks that must be retransmitted via said network over said communication connection.
